(19) United States
(12) Patent Application Publication
(10) Pub. No.: US 2023/0248154 A1
(43) Pub. Date: Aug. 10, 2023

(54) MATTRESS RETAINER EMPLOYING CARRY STRAPS AND BASE CLIPS

(71) Applicant: Ergomotion, Inc., Goleta, GA (US)

(72) Inventors: Joseph Ermalovich, Santa Barbara, CA (US); Carli Hill, Oxnard,, CA (US)

(21) Appl. No.: 17/667,259

(22) Filed: Feb. 8, 2022

(51) Int. Cl. A47C 20/04; A47C 31/08; A61G 7/015

(52) U.S. Cl. CPC A47C 20/04; A47C 31/08; A61G 7/015

(57) ABSTRACT

An adjustable bed has a mattress with a plurality of carry straps attached to an underside of the mattress proximate side edges, a foot end edge and a head end edge. An adjustable foundation has articulating support panels including an upper body support rotatably attached to a seat support section, a thigh support panel rotatably attached the seat support section and a lower leg support panel rotatably attached to the thigh support panel. At least one clip is attached proximate an edge of at least one of the support panels, the at least one clip configured to engage a mating one of the carry straps on the mattress.

### BACKGROUND

### Field

This invention relates generally to the field of adjustable beds and more particularly to a mattress retainer for an articulating bed having an articulating platform, a mattress incorporating carry straps proximate at least two edges and clips located proximate edges of the articulating platform receiving and constraining the carry straps.

### Description of the Related Art

Articulating beds have long been used in hospital and healthcare facilities to allow positioning of a patient in a reclining position, sitting position, elevated leg position or combinations of these positions. General usage of articulating beds has been rapidly expanding due to the comfort and convenience available from adjusting the bed to desired positions for reading, general relaxation or sleeping.

Articulating bed frames provide various mattress support members which articulate relative to one another to provide angled support for the upper body, seat, thighs and lower legs. In the articulated position, a mattress which is firm enough for comfort may not maintain contact with the various articulating support members. It is therefore desirable to have a retention system to maintain engagement of the mattress with the support members.

### SUMMARY

The embodiments disclosed herein overcome the shortcomings of the prior art by providing an adjustable bed having a mattress with a plurality of carry straps attached an underside of the mattress proximate side edges, a foot end edge and a head end edge. An adjustable foundation has articulating support panels including an upper body support rotatably attached to a seat support section, a thigh support panel rotatably attached the seat support section and a lower leg support panel rotatably attached to the thigh support panel. At least one clip is attached proximate an edge of at least one of the support panels, the at least one clip configured to engage a mating one of the carry straps on the mattress.

### BRIEF DESCRIPTION OF THE DRAWINGS

These and other features and advantages of the present invention will be better understood by reference to the following detailed description of exemplary implementations when considered in connection with the accompanying drawings wherein:

FIG. 1 is bottom pictorial representation of a mattress employing carry straps according to the present implementations;

FIGS. 2A and 2B are a top pictoral representation an a top view of an adjustable bed with clips for engagement of the carry straps on the mattress for securing the mattress to the support panels;

FIG. 3 is a detailed pictorial representation of an example clip assembly;

FIG. 4 is a pictorial representation of the adjustable bed with an exploded view of the clip assembly;

FIG. 5 is a detailed exploded side pictorial representation of the adjustable bed with an exploded view of the clip assembly;

FIG. 6 is an end view of the exploded clip assembly;

FIG. 7 is a detailed exploded end view pictorial representation of the clip assembly;

FIG. 8 is a partial pictorial representation of an exploded end view of the clip assembly with a frame implementation of the support panel;

FIG. 9 is a partial pictorial representation showing engagement of the foot end support strap and clip;

FIG. 10 is a partial pictorial representation of an articulate position of the bed with the foot end clip constraining the foot end of the mattress; and,

FIG. 11 is a pictorial representation of replacement of a standard mattress retaining bracket with a foot clip.

### DETAILED DESCRIPTION

Implementations shown in the drawings and described herein provide an adjustable bed having a mattress with carry straps for manipulation during installation and engagement of restraining clips on support panels of an adjustable foundation for limiting separation or translation of the mattress with respect to the support panels during articulation.

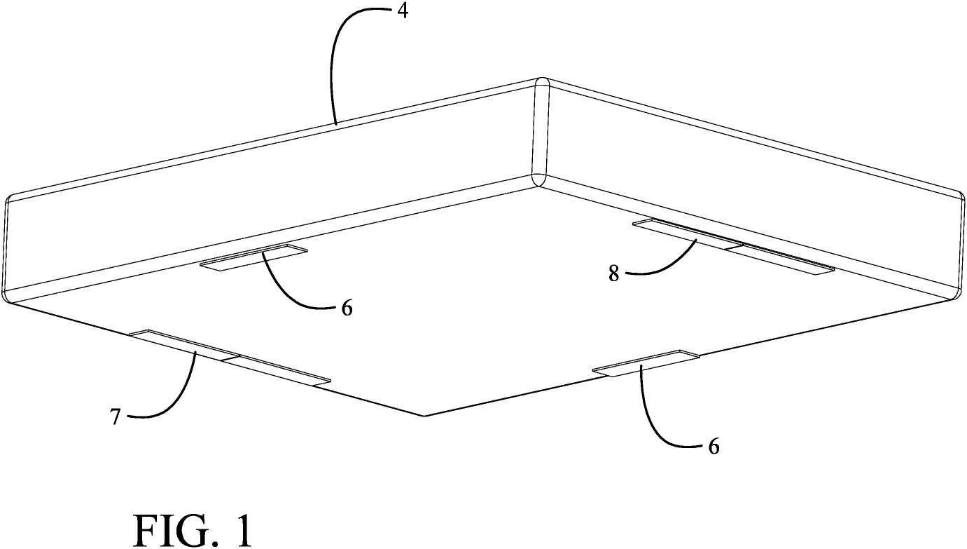

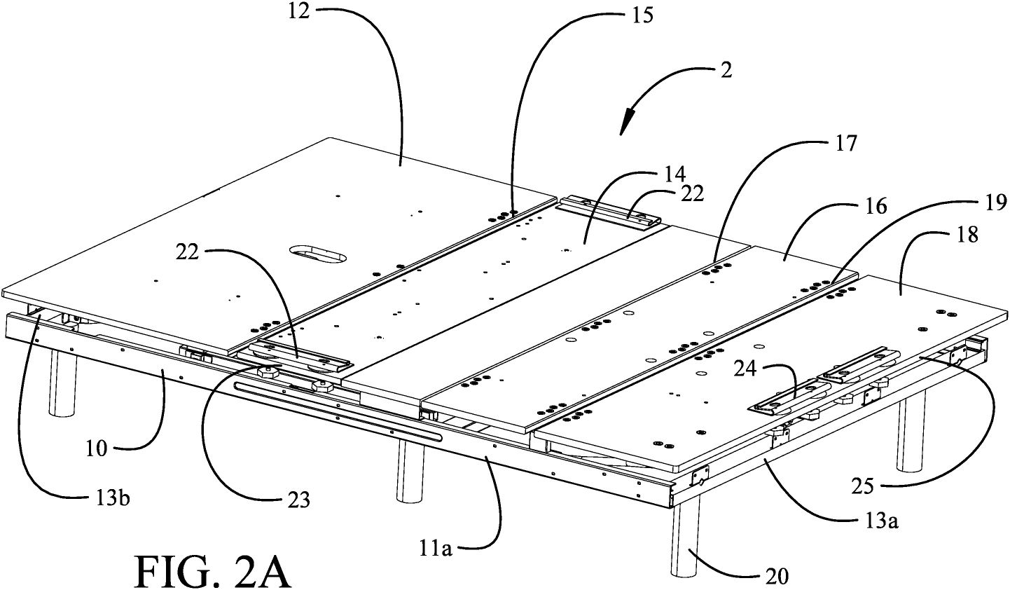

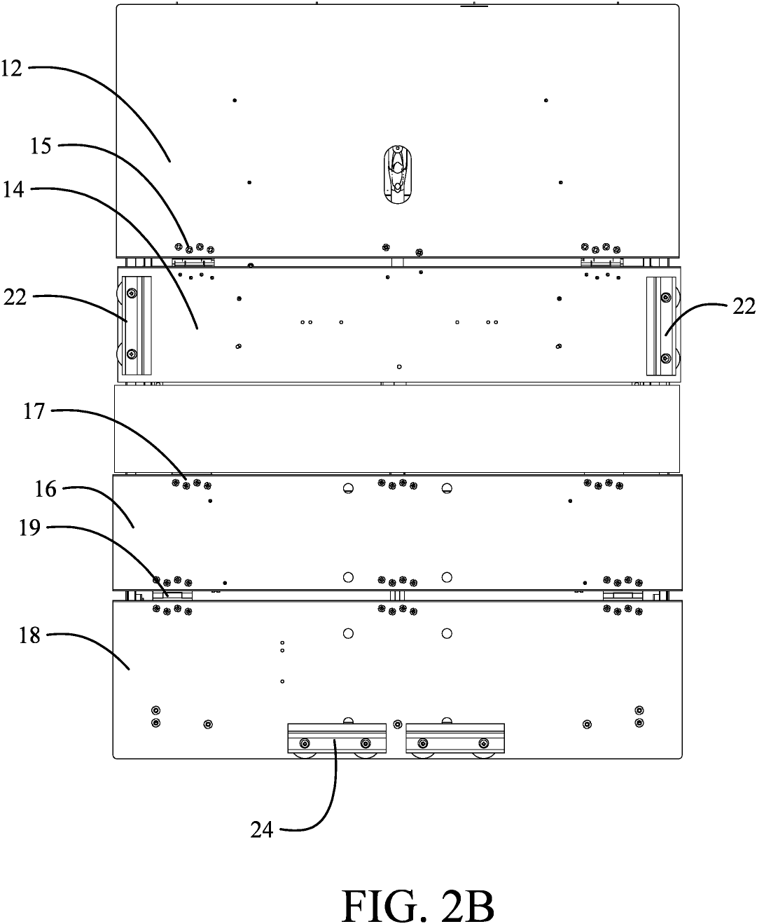

Referring to the drawings, FIG. 1 illustrates an exemplary implementation of a mattress 4 for an adjustable foundation 2 (seen in FIGS. 2A and 2B) which combine to form the adjustable bed system. Side carry straps 6, head end carry straps 7 and foot end carry straps 8 are attached to an underside 9 of the mattress 4 (or a mattress cover). The carry straps are high strength fabric such as [need fabric description] and may be stitched, riveted or adhered to the mattress or mattress cover at locations proximate the edges of the mattress. Mattresses are typically not rigid and difficult to carry and manipulate. The straps provide a means to easily grasp the edges of the mattress for carrying and manipulation in placing the mattress on the adjustable bed.

As seen in FIGS. 2A and 2B, with the adjustable foundation 2 in the unarticulated position, an upper body support panel 12 and a seat support section 14 are carried by a frame 10 having side rails 11a, 11b and end rails 13a, 13b. The upper body support 12 may be attached to the seat support section 14 with hinges 15 for rotation. A thigh support panel 16 may also be rotatably attached with hinges 17 to the seat support section and a lower leg support panel 18 rotatably attached with hinges 19 to the thigh support panel. While shown in the drawings as solid continuous panels, the upper body support, seat support thigh support and lower leg support may be articulating frame elements which support the mattress in the desired locations. The frame 10 may be supported by legs 20. Structure and actuation of the adjustable foundation 2 may be implemented in one example shown herein as disclosed in U.S. Pat. no. 10,932,583 entitled Electric Adjustable Bed.

To secure the mattress 4 to adjustable foundation 2 to maintain position of the mattress during articulation of the various adjustable portions of the bed, clips are mounted to upper surfaces of the support panels. As seen in FIGS. 2A and 2B, side clips 22 are attached to the seat support section 14 proximate lateral edges 23. Foot end clips 24 are attached proximate a foot edge 25 of the lower leg support panel 18. At least one clip is positioned at each location.

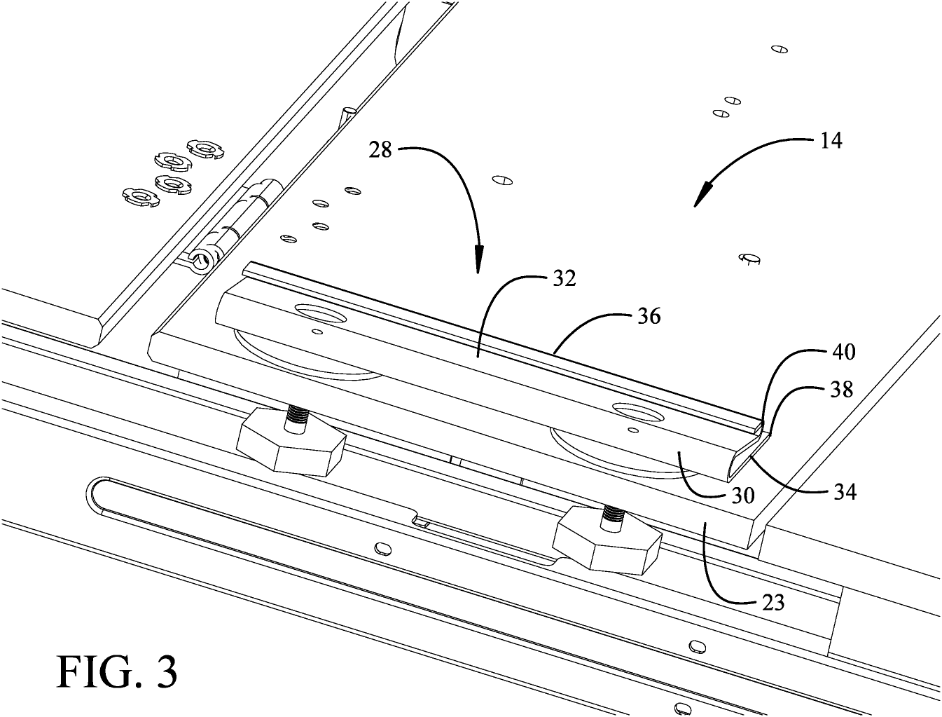

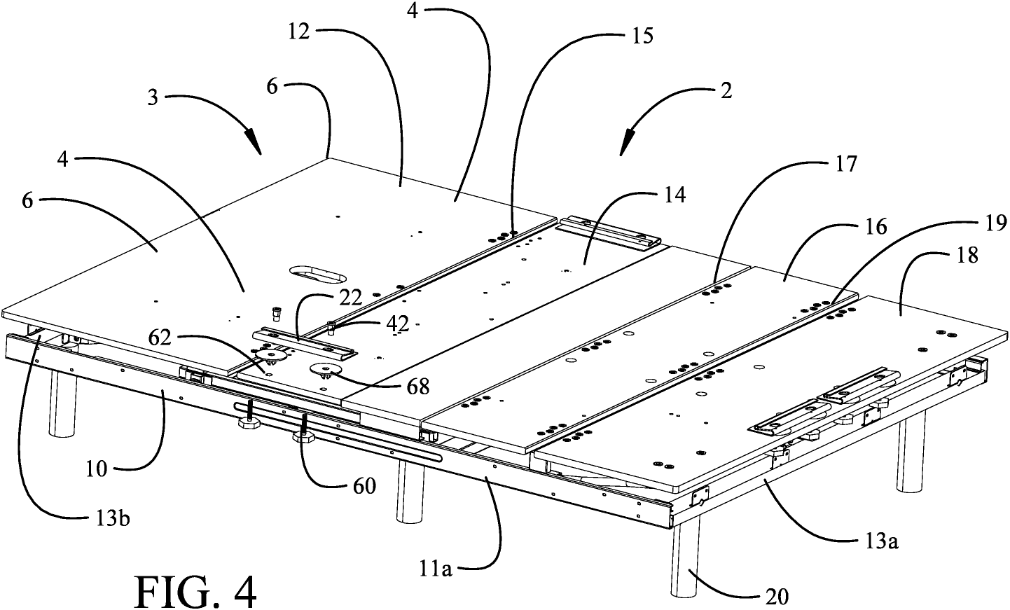

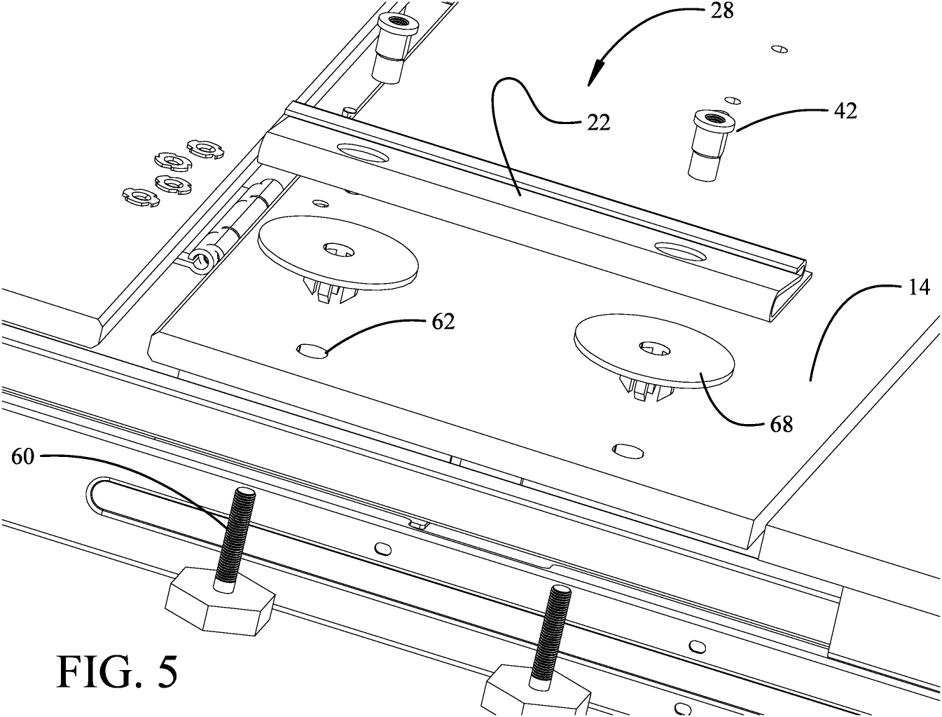

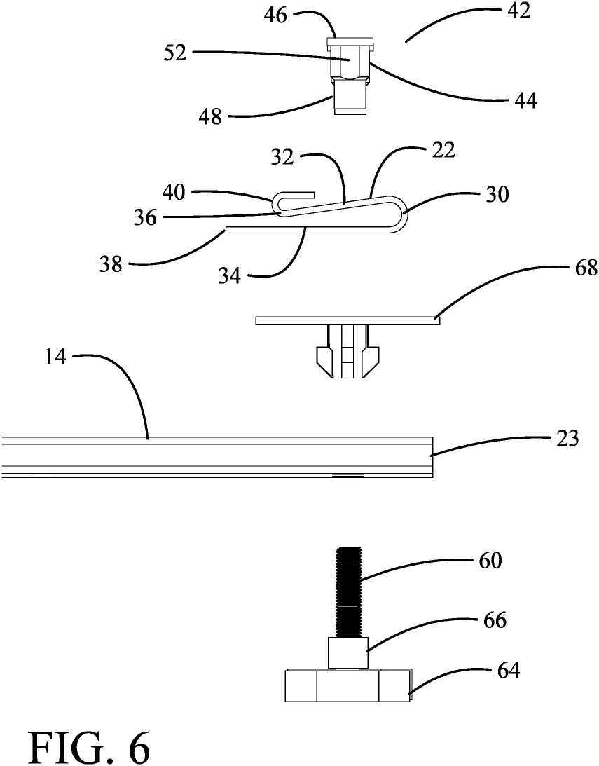

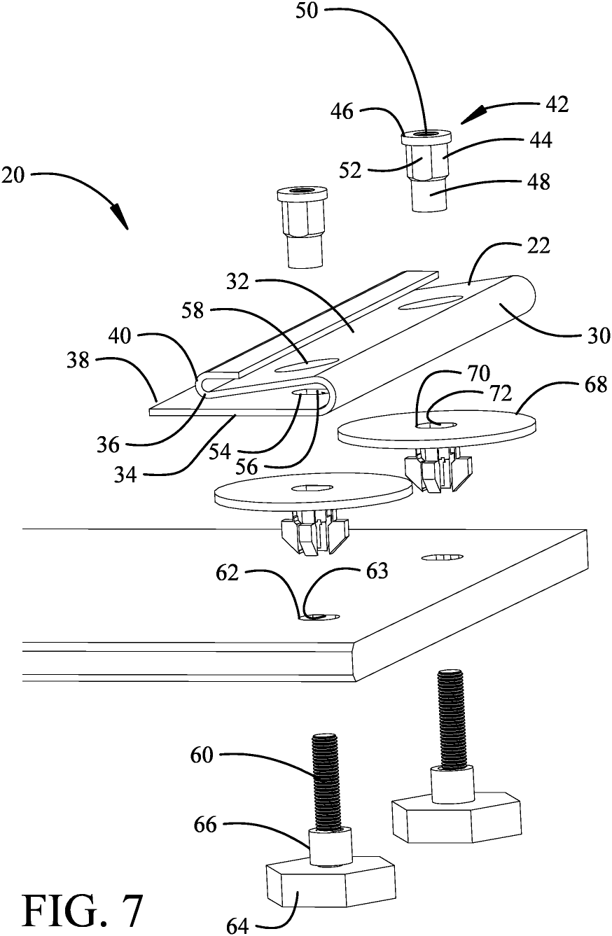

Clip assemblies 28 are employed to attach the clips to the support panels and are shown in detail in FIG. 3 with exploded views in FIGS. 4-7 using side clips 22 as exemplary. The clip assemblies 28 allow use with appropriately configured foundations or retrofitting to existing beds for use with mattresses having the appropriate carrying straps, as will be described in greater detail subsequently. The clips 22, 24 are positioned on the support panels and configured to engage a mating carry strap. Each clip is resilient material such as spring steel and formed from flat plate by bending greater than 180° for a flexible spine 30 with an extending top plate 32 and a bottom plate 34, the flexible spine urging an upper edge 36 of the top plate into contact or close proximity with the bottom plate adjacent a lower edge 38. The strap 6, 8 is frictionally engaged between the top plate and bottom plate at least at the upper and lower edges 36, 38. Flexibility of the spine 30 allows resilient displacement of the top plate 32 and bottom plate 34 for insertion of the strap 6, 8, as will be described subsequently. The upper edge 36 in the example implementation is formed by a reverse bend 40 in the top plate 32 of at least 180° to provide a bulbed protrusion to facilitate insertion of the strap between the top and bottom plates while avoiding a sharp edge on top of the clip that might tear or otherwise damage the lower surface of the mattress.

The clips 22, 24 are secured to the support panels 14, 18 with “nutserts” 42. Each nutsert 42 incorporates a body 44 with a top flange 46 having a first diameter greater than the body. In the example shown, a barrel 48 extends from the body. A threaded bore 50 extends axially through the nutsert 42. The body 44 has flats 52 to engage mating flats in receiving apertures to prevent rotation and the top flange 46 prevents the nutsert from being drawn through the aperture. In the example shown, bottom plate 34 of the clip 22 includes the receiving apertures 54 with mating flats 56 and the top plate 32 has eyes 58 axially aligned with the receiving apertures 54. The eyes 58 have a second diameter greater than the first diameter to allow the nutsert to be inserted through the eye into the receiving aperture. Bolts 60 are configured to be inserted through holes 62 in the support panel 14 and received in the threaded bore 50. In the example shown, the bolts 60 have large heads 64 to allow hand tightening. Additionally, washers or sleeves 66 may be employed over the bolts to adjust tensioning length to prevent the bolts from protruding through the eyes 58 in the top plate 32 of the clip 22. In certain implementations, the holes 62 may have flats 63 to supplement or replace mating flats 56 in the bottom plate 34 of the clip 22.

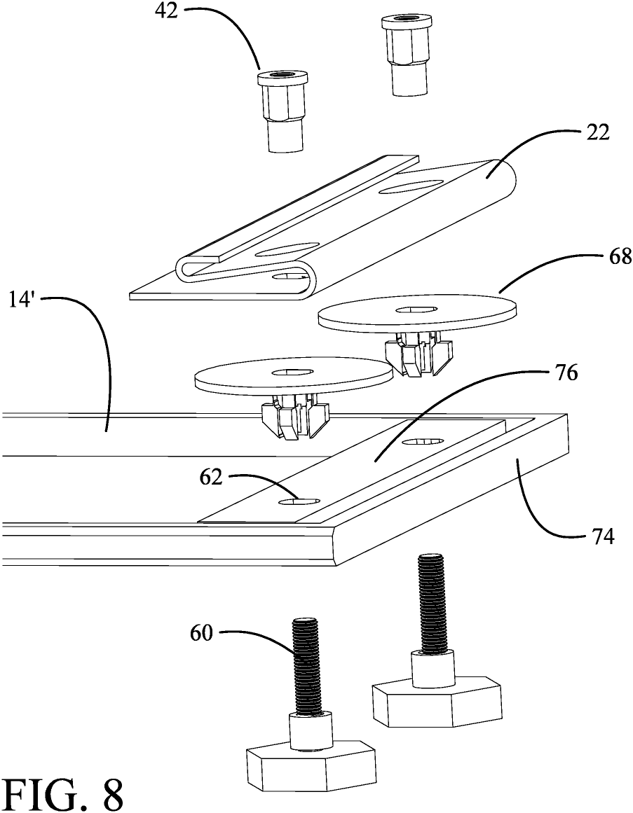

In certain implementations grommet clips 68 inserted in the holes 62 may be employed for sizing or bordering the holes. Through holes 70 in the grommet clips 68 are sized to receive the barrel 48 or body 46 of the nutsert and may also include flats 72 in addition to or as a replacement for flats 52 in the receiving apertures 54 of the clip 22. As seen in FIG. 8, in implementations where the support panels 14′ are frame elements 74, auxiliary panels such as c-channels 76 may be employed to span the frame elements and provide mating apertures 62′ to receive the bolts 60 and secure the clip 22 with or without grommet clips 68.

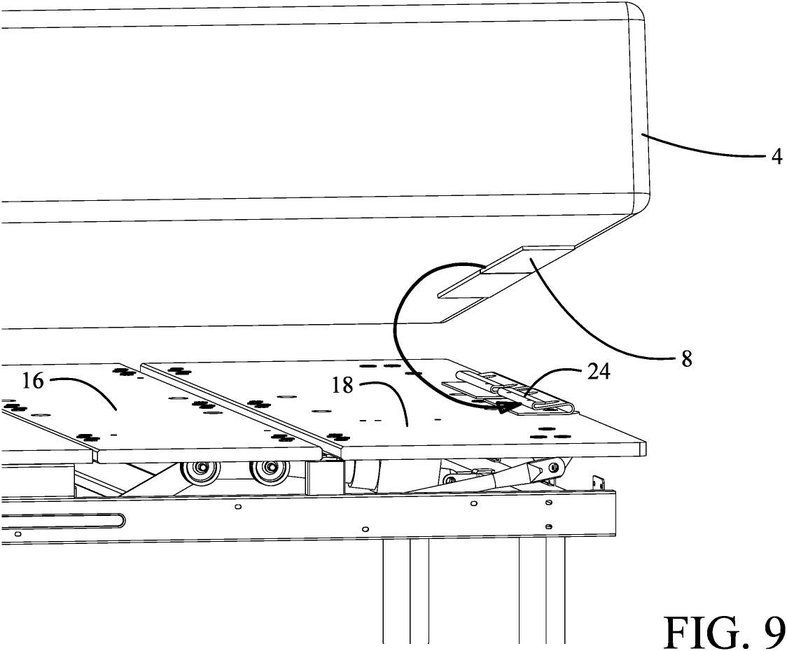

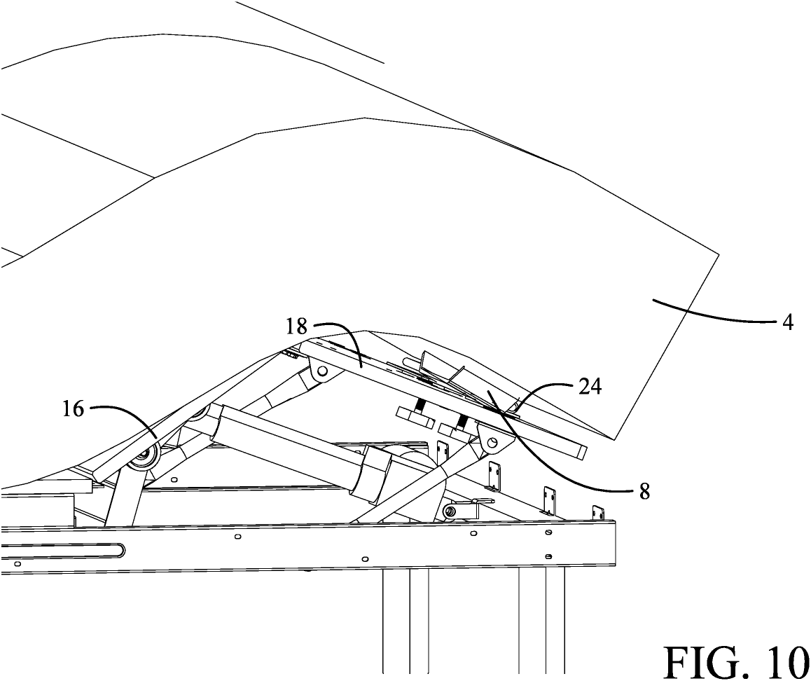

As represented in FIG. 9, securing of the mattress 4 to the adjustable bed 2 is accomplished by slightly displacing or flexing the mattress and strap and urging the strap, for example foot end carry strap 8, through the upper and lower edges 36,38 and between the top plate and bottom plate 32, 34 of the clip 24. The resilience of the clip then frictionally constrains the strap from withdrawing from between the plates and the top plate constrains the mattress from significantly separating from the support panel when in an articulated position as represented in FIG. 10. Use of side clips prevents lateral as well as longitudinal translation of the mattress. With positioning of at least one clip proximate the foot end of the lower leg support panel, the foot end of the mattress is prevented from lifting and constrained against the lower leg support panel upon articulation of the thigh support panel and rotatably attached lower leg support panel. While not typically necessary, clips may be installed at the head end of the upper body support panel to receive the head end carry straps 7 of the mattress 4. Having symmetrical head end carry straps 7 and foot end carry straps 8 allows 180° rotation of the mattress while still allowing engagement of the foot end clip 24.

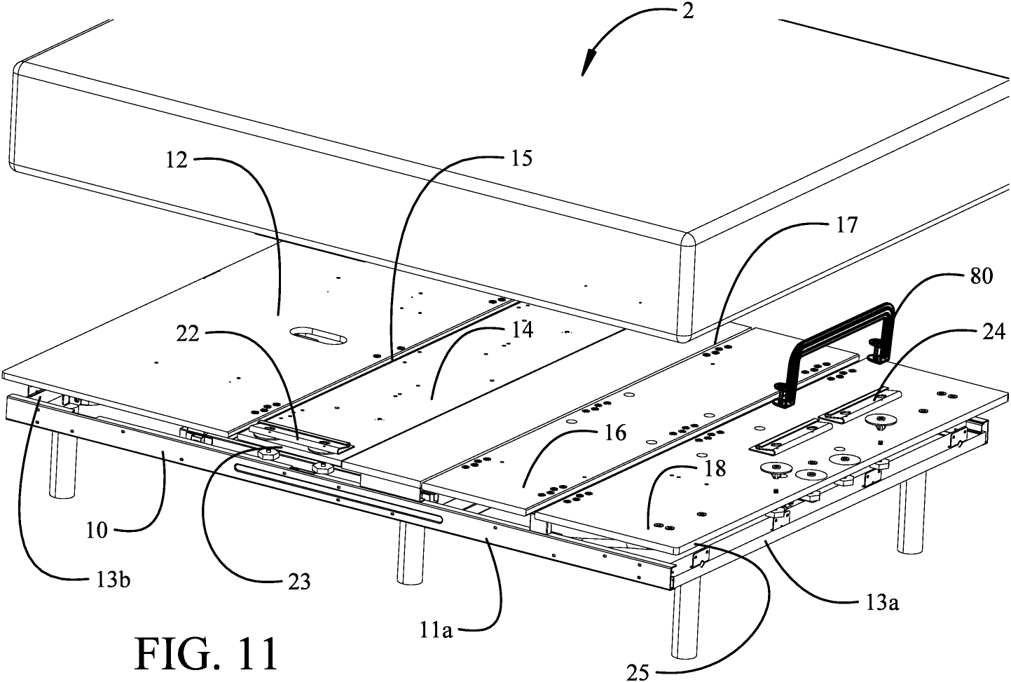

As seen in FIG. 11, a standard mattress retaining bracket 80 may be replaced with a foot clip 24 as described herein for enhanced restraint of the foot of a mattress having carry straps as described herein.

The implementations disclosed provide a method for preventing translation or separation of a mattress on an adjustable foundation. Aa plurality of carry straps are attached to an underside of a mattress proximate side edges, a foot end edge and a head end edge. At least one clip is mounted by attach attaching the clip proximate an edge of at least one support panel in an adjustable foundation having articulating support panels including an upper body support rotatably attached to a seat support section, a thigh support panel rotatably attached the seat support section and a lower leg support panel rotatably attached to the thigh support panel. A mating one of the carry straps on the mattress is then engaged in the at least one clip.

In example implementations, the at least one clip is resilient material flat plate bent greater than 180° for a flexible spine with extending top plate and bottom plate, the flexible spine urging an upper edge of the top plate into contact or close proximity with the bottom plate adjacent a lower edge. Engaging a mating one of the carry straps is accomplished by frictionally engaging the mating one of the carry straps between the top plate and bottom plate at least at the upper and lower edges. With the clip located proximate a foot edge of the lower leg support panel, the foot edge of the mattress is prevented from lifting and constrained against the lower leg support panel upon articulation of the thigh support panel and rotatably attached lower leg support panel.

Additionally, mounting the at least one clip is accomplished by inserting a plurality of nutserts through receiving apertures, each nutsert with a body having a top flange with a first diameter greater than the body, the body having flats to engage mating flats in the receiving apertures to prevent rotation and the top flange prevents the nutsert from being drawn through the aperture. The bottom plate of the clip includes the receiving apertures with mating flats and the top plate has eyes axially aligned with the receiving apertures, the eyes having a second diameter greater than the first diameter to allow the plurality of nutserts to be inserted through the eyes into the receiving apertures. Bolts configured to be received through holes in one of the support panels are inserted through the holed into threaded bores extending axially through each of the plurality of nutserts.

In certain implementations grommet clips are inserted in the holes. The grommet clips have through holes sized to receive the barrel or body of the nutsert and include second flats in addition to or as a replacement for flats in the receiving apertures of the clip.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. An adjustable bed comprising:
a mattress having a plurality of carry straps attached an underside of the mattress proximate side edges, a foot end edge and a head end edge;
an adjustable foundation having articulating support panels including an upper body support rotatably attached to a seat support section, a thigh support panel rotatably attached the seat support section and a lower leg support panel rotatably attached to the thigh support panel; and,
at least one clip attached proximate an edge of at least one of the support panels, said at least one clip configured to engage a mating one of the carry straps on the mattress.

2. The adjustable bed as defined in claim 1 where the at least one clip comprises a foot end clip attached proximate a foot edge of the lower leg support panel.

3. The adjustable bed as defined in claim 2 wherein the at least one clip further comprises side clips attached to the seat support section proximate lateral edges.

4. The adjustable bed as defined in claim 1 wherein the at least one clip comprises resilient material flat plate bent greater than 180° for a flexible spine with extending top plate and bottom plate, the flexible spine urging an upper edge of the top plate into contact or close proximity with the bottom plate adjacent a lower edge, whereby the mating one of the carry straps is frictionally engaged between the top plate and bottom plate at least at the upper and lower edges.

5. The adjustable bed as defined in claim 4 wherein the upper edge is formed by a reverse bend in the top plate of at least 180° to provide a bulbed protrusion thereby facilitating insertion of the strap between the top and bottom plates while avoiding a sharp edge on top of the clip that might tear or otherwise damage the lower surface of the mattress.

6. The adjustable bed as defined in claim 4 further comprising a plurality of nutserts each with a body having a top flange with a first diameter greater than the body, the body having flats to engage mating flats in receiving apertures to prevent rotation and the top flange prevents the nutsert from being drawn through the aperture, a threaded bore extending axially through the nutsert; and wherein the bottom plate of the clip includes the receiving apertures with mating flats and the top plate has eyes axially aligned with the receiving apertures, the eyes having a second diameter greater than the first diameter to allow one of the plurality of nutserts to be inserted through the eyes into the receiving apertures.

7. The adjustable bed as defined in claim 6 further comprising bolts configured to be inserted through holes in one of the support panels and received in the threaded bores.

8. The adjustable bed as defined in claim 7 wherein the bolts have heads adapted to allow hand tightening.

9. The adjustable bed as defined in claim 7 further comprising sleeves received over the bolts to adjust tensioning length to prevent the bolts from protruding through the eyes in the top plate.

10. The adjustable bed as defined in claim 7 further comprising grommet clips inserted in the holes, said grommet clips having through holes sized to receive the barrel or body of the nutsert and including second flats in addition to or as a replacement for flats in the receiving apertures of the clip.

11. A method for preventing translation or separation of a mattress on an adjustable foundation, the method comprising;
attaching a plurality of carry straps to an underside of a mattress proximate side edges, a foot end edge and a head end edge;
mounting at least one clip attached proximate an edge of at least one support panel in an adjustable foundation having articulating support panels including an upper body support rotatably attached to a seat support section, a thigh support panel rotatably attached the seat support section and a lower leg support panel rotatably attached to the thigh support panel; and
engaging a mating one of the carry straps on the mattress in the at least one clip.

12. The method as defined in claim 11 wherein the at least one clip comprises resilient material flat plate bent greater than 180° for a flexible spine with extending top plate and bottom plate, the flexible spine urging an upper edge of the top plate into contact or close proximity with the bottom plate adjacent a lower edge, and wherein the step of engaging a mating one of the carry straps comprises frictionally engaging the mating one of the carry straps between the top plate and bottom plate at least at the upper and lower edges.

13. The method of claim 11 wherein in the step of mounting at least one clip comprises:
inserting a plurality of nutserts through receiving apertures, each nutsert with a body having a top flange with a first diameter greater than the body, the body having flats to engage mating flats in the receiving apertures to prevent rotation and the top flange prevents the nutsert from being drawn through the aperture wherein the bottom plate of the clip includes the receiving apertures with mating flats and the top plate has eyes axially aligned with the receiving apertures, the eyes having a second diameter greater than the first diameter to allow the plurality of nutserts to be inserted through the eyes into the receiving apertures; and
inserting bolts configured to be received through holes in one of the support panels and receiving the bolts in threaded bores extending axially through each of the plurality of nutserts.

14. The method as defined in claim 13 further comprising inserting grommet clips in the holes, said grommet clips having through holes sized to receive the barrel or body of the nutsert and including second flats in addition to or as a replacement for flats in the receiving apertures of the clip.
